(19) United States
(12) Patent Application Publication
(10) Pub. No.: US 2026/0155394 A1
(43) Pub. Date: Jun. 4, 2026

(54) METHOD FOR PRODUCING ACTIVE MATERIAL LAYER AND BATTERY, AND ELECTRODE STACK AND BATTERY

(71) Applicant: TOYOTA JIDOSHA KABUSHIKI KAISHA, Aichi-ken (JP)

(72) Inventors: Satoshi NAKASHIMA, Toyota-shi (JP); Jun IZUMI, Toyota-shi (JP); Tomofumi HIRUKAWA, Miyoshi-shi (JP); Masashi UEDA, Toyota-shi (JP)

(21) Appl. No.: 19/367,824

(22) Filed: Oct. 24, 2025

(30) Foreign Application Priority Data
Dec. 4, 2024 (JP) 2024-211546

(51) Int. Cl. H01M 4/70; H01M 4/04

(52) U.S. Cl. CPC H01M 4/70; H01M 4/0404; H01M 4/0433

(57) ABSTRACT

The present disclosure provides a method for forming grooves with arbitrary shapes. A method of the disclosure for producing an active material layer comprises coating ethylene carbonate 200 onto an electrode mixture layer having a specified pattern, and pressing the electrode mixture layer coated with the ethylene carbonate 200 to obtain an active material layer having grooves corresponding to the specified pattern.

### FIELD

The present disclosure relates to a method for producing an active material layer and a battery, as well as to an electrode stack and to a battery.

### BACKGROUND

An electrode stack has, for example, a positive electrode collector layer, a positive electrode active material layer, a solid electrolyte layer or separator, a negative electrode active material layer and a negative electrode collector layer in that order, the battery having the electrode stack housed in an outer container. For a battery comprising an electrolyte solution, it has been proposed to provide slits or grooves on the active material layer or on the separator in order to improve diffusibility of the electrolyte solution during injection, and emission of gas during charge-discharge (PTLs 1 to 6).

PTL 1, for example, discloses a secondary battery comprising an electrode group having a positive plate and a negative plate, each with a combination layer comprising an active material formed on the surface of a current collector, wound or layered via a separator, wherein a plurality of grooves are formed on the surface of the combination layer of either or both the positive plate and negative plate, the grooves having curved sections at the side edges and the bottom center section of each groove. The secondary battery described in PTL 1 is considered has excellent impregnability for the electrolyte solution, and excellent cycle characteristics and reliability.

PTL 2 discloses a non-aqueous electrolyte secondary battery wherein grooves are formed on the surface of the active material layer from one edge extending in the lengthwise direction of the electrode plate, to the other edge, with the cross-sectional area of the grooves increasing from the center section toward the edge of the electrode plate. The non-aqueous electrolyte secondary battery described in PTL 2 has the grooves formed on the electrode surface, making it possible to increase both diffusion of the injected electrolyte solution into the power generating element and gas removal from the power generating element, as well as the removal speed of the solvent.

PTL 3 discloses a nonaqueous electrolyte solution secondary battery comprising an electrode group having a high-density positive electrode with a positive electrode active material layer formed on at least one side of a positive electrode collector, a high-density negative electrode with a negative electrode active material layer formed on at least one side of a negative electrode collector, and a separator situated between the positive and negative electrodes, with a nonaqueous electrolyte solution being impregnated into the electrode group, wherein the specific surface area per unit area of the positive electrode active material layer of the positive electrode is 0.5 to 1.0 times the specific surface area per unit area of the negative electrode active material layer of the negative electrode which is facing the positive electrode across the separator. The nonaqueous electrolyte solution secondary battery described in PTL 3 is designed to stabilize the initial properties, and especially the discharge characteristic during high current discharge, and to improve the charge-discharge cycle characteristic.

PTL 4 discloses a nonaqueous electrolyte solution battery constructed with an external body housing an electrode body, formed with a separator situated between a positive electrode and negative electrode, and a nonaqueous electrolyte solution, the positive electrode and negative electrode having an electrode mixture layer comprising an active material on one or both sides of a current collector, wherein the electrode mixture layer present on at least one side of either or both the positive electrode and negative electrode has a thickness of 100 μm or greater and a plurality of grooves with openings on the surface on the opposite side from the current collector, the width L1 of the grooves being 100 to 800 μm, and the pitch L2 between adjacent grooves being 2 to 5 mm. The nonaqueous electrolyte solution battery described in PTL 4 is considered to have high electric power generation efficiency, while using electrodes with a thick electrode mixture layer.

PTL 5 discloses a separator to be used in a power storage device comprising an electrode body, having a positive/negative electrode multilayer structure in which a positive electrode and negative electrode are layered via a separator, a case that houses the electrode body, and an electrolyte, wherein the separator has one or more grooves extending from the end of the separator forming one positive/negative electrode multilayer structure, along the direction toward the other end. The separator described in PTL 5 satisfactorily improves the impregnability of the electrolyte.

PTL 6 discloses a nonaqueous electrolyte solution battery having a nonaqueous electrolyte solution injected into a stack obtained by stacking a positive electrode and negative electrode via a separator, wherein roughening treatment is carried out on at least one side of the separator. The nonaqueous electrolyte solution battery described in PTL 6 shortens the time for permeation of the electrolyte solution into the electrode group, and is thus considered to be a nonaqueous electrolyte solution battery with satisfactory mass productivity.

### CITATION LIST

### Patent Literature

[PTL 1] International Patent Publication No. WO2008/053880

[PTL 2] Japanese Unexamined Patent Publication No. 2004-207253

[PTL 3] Japanese Unexamined Patent Publication No. 2004-006275

[PTL 4] Japanese Unexamined Patent Publication No. 2012-181978

[PTL 5] Japanese Unexamined Patent Publication No. 2024-092439

[PTL 6] Japanese Unexamined Patent Publication HEI No. 06-333550

### SUMMARY

### Technical Problem

In the methods described in PTLs 1 to 6, grooves are formed by pressing using a roller (roll pressing), the roll having a surface with convex protrusions or roughness produced by roughening treatment. This method allows formation of groove sections with a pattern corresponding to the protrusions on the roll surface. However there is a limit to the intricacy of groove patterns that can be formed by roll pressing, and therefore repeating patterns are most common.

It is an object of the present disclosure to provide a method for forming grooves with arbitrary shapes.

### Solution to Problem

The present disclosure achieves the object described above by the following means.

### (Aspect 1)

A method for producing an active material layer, wherein the method comprises:
coating ethylene carbonate onto an electrode mixture layer having a specified pattern, and
pressing the electrode mixture layer coated with the ethylene carbonate to obtain an active material layer having grooves corresponding to the specified pattern.

### (Aspect 2)

The method according to aspect 1, wherein the grooves have one or more of the following structures:
(i) a structure in which the grooves extend out in the in-plane direction in an approximately radial manner from one end face side near the injection hole of the active material layer, toward the other end face side of the active material layer,
(ii) a structure in which the grooves form branched fluid channels extending in the in-plane direction,
(iii) a structure in which the grooves do not reach to at least one edge of the active material layer, and
(iv) a structure in which the grooves are spiral or spider web-like.

### (Aspect 3)

A method for producing a battery,
wherein the battery has a first current collector layer, a first active material layer, a solid electrolyte layer or separator, a second active material layer and a second current collector layer, in that order, and
the method comprises producing the first and/or second active material layers by the method according to aspect 1 or 2.

### (Aspect 4)

An electrode stack having an active material layer and a current collector layer in contact with the active material layer,
the electrode stack having grooves on the side of the active material layer opposite the current collector layer side, and
the grooves having at least one of the following structures:
(i) a structure in which the grooves extend out in the in-plane direction in an approximately radial manner from one end face side near the injection hole of the active material layer, toward the other end face side of the active material layer,
(ii) a structure in which the grooves form branched fluid channels extending in the in-plane direction,
(iii) a structure in which the grooves do not reach to at least one edge of the active material layer, and
(iv) a structure in which the grooves are spiral or spider web-like.

### (Aspect 5)

A battery having a first current collector layer, a first active material layer, a solid electrolyte layer or separator, a second active material layer and a second current collector layer in that order,
wherein a combination of the first current collector layer and first active material layer and/or a combination of the second current collector layer and second active material layer forms an electrode stack according to aspect 4.

### Advantageous Effects of Invention

According to the method of the present disclosure it is possible to form grooves with arbitrary shapes.

### BRIEF DESCRIPTION OF DRAWINGS

FIG. 1 is a schematic diagram illustrating a step of coating ethylene carbonate.

FIG. 2 is a schematic diagram illustrating a pressing step.

FIG. 3 is a schematic diagram illustrating a groove pattern.

FIG. 4A is an image of an active material layer for an Example of the disclosure.

FIG. 4B is an image of an active material layer for an Example of the disclosure.

FIG. 4C is an image of an active material layer for an Example of the disclosure.

### DESCRIPTION OF EMBODIMENTS

### Method for Producing Active Material Layer

The method of the disclosure for producing an active material layer comprises:
coating the electrode mixture layer with ethylene carbonate in a specified pattern, and
pressing the electrode mixture layer coated with the ethylene carbonate to obtain an active material layer having grooves corresponding to the specified pattern.

This method allows formation of grooves with arbitrary shapes.

As mentioned above, in methods disclosed in the prior art, slits or grooves are provided on the active material layer to improve diffusibility of the electrolyte solution during injection, and emission of gas during charge-discharge. In this case, the pattern of the slits and grooves is formed by transferring the pattern of a pressure roller, and it is therefore a repeating pattern.

With the method of the disclosure, however, ethylene carbonate is coated onto the electrode mixture layer in a specified pattern, and the electrode mixture layer coated with the ethylene carbonate is pressed to obtain an active material layer having grooves corresponding to the specified pattern. This allows grooves to be formed in any desired pattern, allowing formation of patterns that cannot be formed by pressure roller transfer.

In addition, since ethylene carbonate is in a solid state at ordinary temperature (25° C.), and is an electrolyte component, there is no need for dry removal of the ethylene carbonate after film formation, allowing the method of the disclosure to be used even when the entire film-forming step is carried out by dry film formation.

Embodiments of the disclosure will now be explained in detail. However, the present disclosure is not limited to the embodiments described below, and various modifications may be implemented which do not depart from the gist thereof. Similar elements in the drawings are indicated by like reference numerals and will be explained only once.

### Ethylene Carbonate Coating Step

In the method of the disclosure for producing an active material layer, first ethylene carbonate is coated onto the electrode mixture layer in a specified pattern.

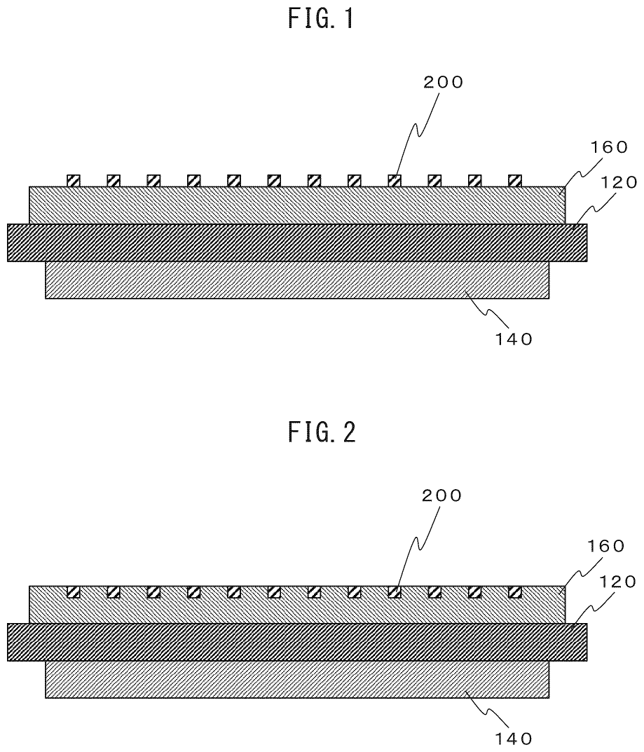

FIG. 1 shows an embodiment of the present disclosure, which however is not limitative. FIG. 1 shows a cross-sectional view of an active material layer. A negative electrode mixture layer 160 is disposed on the top side of the current collector layer 120 and a positive electrode mixture layer 140 is disposed on the bottom side. Ethylene carbonate 200 is disposed on part of the surface of the negative electrode mixture layer 160.

The ethylene carbonate may be coated in a specified pattern. At least a portion of the coated ethylene carbonate pattern corresponds to a pattern of grooves formed after pressing.

According to the present disclosure, the specified pattern is not particularly restricted and may be striped, lattice-like, or any of the following forms:
(i) a structure in which the specified pattern extends in the in-plane direction in an approximately radial manner from the end face side near the injection hole of the active material layer toward the other end face side of the active material layer,
(ii) a structure in which the specified pattern forms branched fluid channels extending in the in-plane direction,
(iii) a structure in which the specified pattern does not reach to at least one edge of the active material layer, or
(iv) a structure in which the specified pattern is spiral or spider web-like.

### (Active Material Layer)

For the purpose of the disclosure, the active material layer is fabricated by pressing the electrode mixture layer, and it has voids in a specified pattern.

The thickness of the active material layer is not particularly restricted, and may be 0.1 μm or greater, 1 μm or greater, 3 μm or greater, 5 μm or greater or 10 μm or greater, and 1 mm or smaller, 700 μm or smaller, 500 μm or smaller, 300 μm or smaller or 100 μm or smaller.

### (Electrode Mixture Layer)

The electrode mixture layer of the disclosure comprises at least active material particles. If necessary, the active material layer may further comprise one or more components such as a solid electrolyte, conductive aid or binder.

The types of solid electrolyte, conductive aid and binder optionally included in the active material layer are not particularly restricted. The contents of the solid electrolyte, conductive aid and binder optionally included in the active material layer are also not particularly restricted.

### Pressing Ste

In the method of the disclosure for producing an active material layer, the ethylene carbonate-coated electrode mixture layer is then pressed to obtain an active material layer having grooves corresponding to the specified pattern.

FIG. 2 shows an embodiment of the present disclosure, which however is not limitative. By pressing the electrode mixture layer, the ethylene carbonate 200 disposed on the surface of the negative electrode mixture layer 160 forms grooves on the surface of the negative electrode mixture layer and infiltrates into the grooves.

The method of pressing according to the disclosure may be roll pressing using a roll with a smooth surface, or surface pressing, with no limitation to these.

According to the disclosure, the pressure during roll pressing is not particularly restricted and may be 5 kN/cm or greater, 10 kN/cm or greater, 50 kN/cm or greater, 80 kN/cm or greater or 100 kN/cm or greater, and 500 kN/cm or lower, 300 kN/cm or lower, 200 kN/cm or lower or 100 kN/cm or lower.

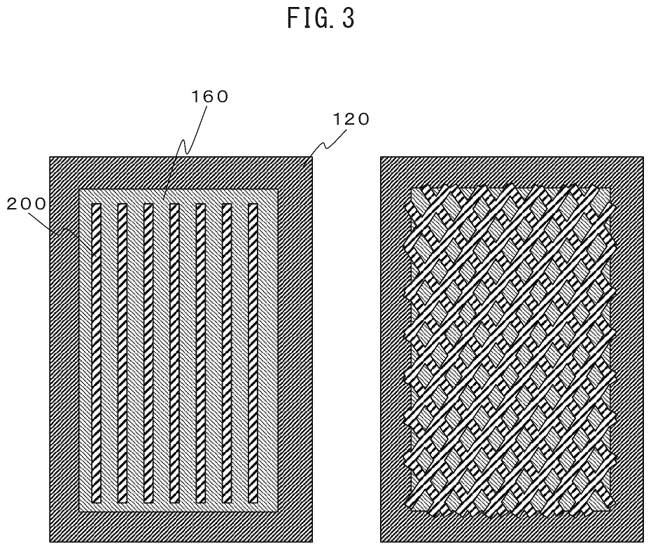

The shapes of the grooves may be any desired shapes, such as striped or lattice-like shapes as shown in FIG. 3, for example. In particular, grooves having one or more of the following shapes are more preferred for the method of the disclosure, because they are difficult to form using a pressure roller:
(i) a structure in which the grooves extend out in the in-plane direction in an approximately radial manner from one end face side near the injection hole of the active material layer, toward the other end face side of the active material layer,
(ii) a structure in which the grooves form branched fluid channels extending in the in-plane direction,
(iii) a structure in which the grooves do not reach to at least one edge of the active material layer, or
(iv) a structure in which the grooves are spiral or spider web-like.

For example, grooves having the structure of (iii) can help prevent breakdown of the active material layer while improving impregnability of the electrolyte solution, thus allowing the method of the disclosure to be utilized in a more preferred manner.

According to the disclosure, the ethylene carbonate may be removed from the surface of the active material layer after the pressing step to form grooves on the surface of the active material layer. The method of removing the ethylene carbonate may be melting of the ethylene carbonate by heating it at or above the melting point of the ethylene carbonate (approximately 36.4° C.), or dissolution of the ethylene carbonate with the electrolyte solution, although there is no limitation to these.

As mentioned above, ethylene carbonate is a component that is often present in the electrolyte solution. Therefore, it is not necessary to carry out a step of drying removal of the ethylene carbonate used for formation of the grooves after formation of the active material layer. In particular, since it is not necessary to carry out a drying step after the active material layer has been formed, the method of the disclosure can be effectively utilized even for dry film formation of the active material layer.

### Method for Producing Battery

In the method of the disclosure for producing a battery:
the battery has a first current collector layer, a first active material layer, a solid electrolyte layer or separator, a second active material layer and a second current collector layer, in that order, and
the first and/or second active material layers are produced by the method of the disclosure.

### Injection Step

According to the disclosure, the method for producing a battery may also include a step of injecting the electrolyte solution, i.e. an injection step. By injecting the electrolyte solution, the ethylene carbonate on the surface of the active material layer can dissolve in the electrolyte solution over a sufficient period of time, thereby removing the ethylene carbonate from the surface of the active material layer and forming grooves on the surface of the active material layer.

The electrolyte solution to be injected in the injection step is not particularly restricted. Even if the ethylene carbonate content of the electrolyte solution that is injected in the injection step is reduced from the desired content by the amount in the electrode stack, it will be possible to obtain an electrolyte solution with the desired ethylene carbonate content in the electrode stack module.

### Electrode Stack

The electrode stack of the disclosure is an electrode stack having an active material layer and a current collector layer in contact with the active material layer, and
having grooves on the side of the active material layer opposite the current collector layer side,
wherein the grooves have at least one of the following structures:
(i) a structure in which the grooves extend out in the in-plane direction in an approximately radial manner from one end face side near the injection hole of the active material layer, toward the other end face side of the active material layer,
(ii) a structure in which the grooves form branched fluid channels extending in the in-plane direction,
(iii) a structure in which the grooves do not reach to at least one edge of the active material layer, and
(iv) a structure in which the grooves are spiral or spider web-like.

### Battery

The battery of the disclosure has a first current collector layer, a first active material layer, a solid electrolyte layer or separator, a second active material layer and a second current collector layer in that order,
wherein a combination of the first current collector layer and first active material layer and/or a combination of the second current collector layer and second active material layer forms an electrode stack of the disclosure.

The present disclosure will now be explained in further detail by an Example, with the understanding that the scope of the disclosure is not limited thereby.

### EXAMPLES

### Coating of Ethylene Carbonate

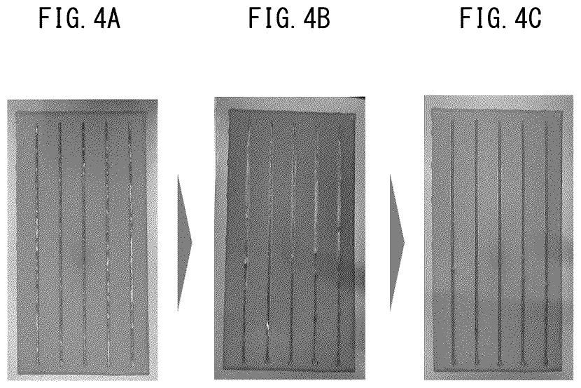

Ethylene carbonate that had been heated at or above its melting point to melting was coated in a striped manner onto a negative electrode mixture layer. The coated negative electrode mixture layer is shown in FIG. 4A. The coated ethylene carbonate was cooled to ordinary temperature (25° C.), which maintained the striped form on the surface of the negative electrode mixture layer.

### Pressing

The coated negative electrode mixture layer was roll pressed under conditions of ordinary temperature (25° C.) and 14 kN/cm. A pressed negative electrode active material layer is shown in FIG. 4B. The ethylene carbonate formed grooves in the negative electrode mixture layer while maintaining the coated striped form.

### Melting of Ethylene Carbonate

The pressed electrode was heated at 37.0° C. to melt the ethylene carbonate and impregnate it into the negative electrode mixture layer. A negative electrode active material layer with melted ethylene carbonate is shown in FIG. 4C. As shown in FIG. 4C, grooves formed by ethylene carbonate could be observed on the surface of the negative electrode mixture layer.

### Evaluation

As seen in FIGS. 4A to 4C, this Example confirmed that it is possible to form grooves corresponding to arbitrary shapes of coating with ethylene carbonate.

### REFERENCE SIGNS LIST

120 Current collector layer
140 Positive electrode mixture layer
160 Negative electrode mixture layer
200 Ethylene carbonate

1. A method for producing an active material layer, wherein the method comprises:
coating ethylene carbonate onto an electrode mixture layer having a specified pattern, and
pressing the electrode mixture layer coated with the ethylene carbonate to obtain an active material layer having grooves corresponding to the specified pattern.

2. The method according to claim 1, wherein the grooves have one or more of the following structures:
(i) a structure in which the grooves extend out in the in-plane direction in an approximately radial manner from one end face side near the injection hole of the active material layer, toward the other end face side of the active material layer,
(ii) a structure in which the grooves form branched fluid channels extending in the in-plane direction,
(iii) a structure in which the grooves do not reach to at least one edge of the active material layer, and
(iv) a structure in which the grooves are spiral or spider web-like.

3. A method for producing a battery,
wherein the battery has a first current collector layer, a first active material layer, a solid electrolyte layer or separator, a second active material layer and a second current collector layer, in that order, and
the method comprises producing the first and/or second active material layers by the method according to claim 1.

4. An electrode stack having an active material layer and a current collector layer in contact with the active material layer,
the electrode stack having grooves on the side of the active material layer opposite the current collector layer side, and
the grooves having at least one of the following structures:
(i) a structure in which the grooves extend out in the in-plane direction in an approximately radial manner from one end face side near the injection hole of the active material layer, toward the other end face side of the active material layer,
(ii) a structure in which the grooves form branched fluid channels extending in the in-plane direction,
(iii) a structure in which the grooves do not reach to at least one edge of the active material layer, and
(iv) a structure in which the grooves are spiral or spider web-like.

5. A battery having a first current collector layer, a first active material layer, a solid electrolyte layer or separator, a second active material layer and a second current collector layer in that order,
wherein a combination of the first current collector layer and first active material layer and/or a combination of the second current collector layer and second active material layer forms an electrode stack according to claim 4.
